(19) United States
(12) Patent Application Publication
(10) Pub. No.: US 2007/0197675 A1
(43) Pub. Date: Aug. 23, 2007

(54) Low-resilience highly air-permeable polyurethane foam and use thereof

(75) Inventor: Hiroyuki Matsumoto, Yokohama-shi (JP)

Correspondence Address: SUGHRUE MION, PLLC, 2100 PENNSYLVANIA AVENUE, N.W., SUITE 800, WASHINGTON, DC, 20037, US

(73) Assignee: BRIDGESTONE CORPORATION

(21) Appl. No.: 11/504,089

(22) Filed: Aug. 15, 2006

Related U.S. Application Data
(63) Continuation of application No. PCT/JP05/02300, filed on Feb. 16, 2005.

(30) Foreign Application Priority Data
Feb. 17, 2004 (JP) 2004-040293

(51) Int. Cl. C08G 18/00

(52) U.S. Cl. 521/174

(57) ABSTRACT

A low-resilience highly air-permeable polyurethane foam is prepared by the foaming of a polyurethane raw material containing a polyol component, a polyisocyanate component, a catalyst, and a blowing agent, followed by removal of a foam skin (reticulation). This polyurethane foam has a glass transition point near room temperature and a cell number (cell count) of 25 PPI or less. The polyurethane foam has a large air bubble size as indicated by a cell number of 25 PPI or less. In addition, because the skin of the polyurethane foam is removed, it has high air permeability. Since the polyurethane foam comes into contact with human body at fewer points, unpleasantness, such as “stuffy” feeling, can be reduced. Since the polyurethane foam has large air bubbles, it exhibits excellent drainability and dries in a shorter time.

### CROSS REFERENCE TO RELATED APPLICATION

This is a continuation application of PCT/JP2005/002300 filed on Feb. 16, 2005.

### TECHNICAL FIELD

The present invention relates to a low-resilience highly air-permeable polyurethane foam, and a bed item and a vehicle seat pad including the low-resilience highly air-permeable polyurethane foam.

### BACKGROUND ART

A low-resilience polyurethane foam is known for its excellent shock absorbency and excellent vibration absorbency. When the low-resilience polyurethane foam is used as a cushioning material or a mattress material, it makes the body pressure distribution uniform and reduces a feeling of fatigue and decubitus. Because of its excellent shock absorbency, excellent vibration absorbency, and excellent cushioning characteristics, the low-resilience polyurethane foam is used in a mattress, a pillow, and a seat pad for a vehicle, such as an automobile.

The low-resilience polyurethane foam is formulated by selecting the composition of the polyurethane foam, specifically, the type of polyisocyanate or the number of functional groups and the hydroxyl value of a polyol so that the glass transition can occur at its service temperature (typically room temperature). The glass transition provides low resilience (Japanese Unexamined Patent Application Publication No. 11-286566).

In existing low-resilience polyurethane foams, air bubbles constituting the foams have small diameters; in general, the cell number (cell count) on a line having a length of 25.4 mm is more than 20 pores per inch (PPI). For example, existing low-resilience polyurethane foams have fine air bubbles of about 40 to 50 PPI.

Because the air bubble size is small, the existing low-resilience polyurethane foams are inferior in air permeability. Items such as mattresses, pillows, and vehicle seat pads are often in contact with human body for many hours. Thus, such an item that is formed of a low-resilience polyurethane foam having lower air permeability makes people feel “stuffy” over time, gives no comfortable feeling, and in an extreme case exacerbates decubitus. Such an item that is formed of a low-resilience polyurethane foam having a small air bubble size exhibits poor drainability after washing and takes a long time to dry.

### DISCLOSURE OF INVENTION

It is an object of the present invention to overcome the disadvantages of the existing low-resilience polyurethane foams and provide a low-resilience polyurethane foam exhibiting high air permeability and excellent drainability.

It is another object of the present invention to provide a bed item and a vehicle seat pad that give comfortable feeling using such a low-resilience highly air-permeable polyurethane foam.

A low-resilience highly air-permeable polyurethane foam according to the present invention is prepared by the foaming of a polyurethane raw material containing a polyol component, a polyisocyanate component, a catalyst, and a blowing agent, followed by removal of a foam skin (reticulation). The low-resilience highly air-permeable polyurethane foam according to the present invention has a glass transition point near room temperature and a cell count of 25 PPI or less.

A low-resilience highly air-permeable polyurethane foam according to the present invention has a large air. bubble size as indicated by a cell count of 25 PPI or less. In addition, because the skin of the polyurethane foam is removed, it has high air permeability. Since this polyurethane foam comes into contact with human body at fewer points, unpleasantness, such as “stuffy” feeling, can be reduced. Furthermore, since this polyurethane foam has large air bubbles, it exhibits excellent drainability and dries in a shorter time.

A bed item according to the present invention includes this low-resilience highly air-permeable polyurethane foam. The bed item may be formed only of the low-resilience highly air-permeable polyurethane foam. The bed item may have a multilayered structure composed of the low-resilience highly air-permeable polyurethane foam and another material, wherein the low-resilience highly air-permeable polyurethane foam is provided as a surface layer.

A vehicle seat pad according to the present invention includes a main body of a seat pad and a skin material covering the main body of a seat pad, wherein the skin material is lined with the low-resilience highly air-permeable polyurethane foam.

### BRIEF DESCRIPTION OF THE DRAWINGS

FIG. 1 is a graph illustrating the drying speed of polyurethane foams of Example 4 and Comparative Example 5.

### BEST MODE FOR CARRYING OUT THE INVENTION

Preferred embodiments of the present invention will be described in detail below.

A low-resilience highly air-permeable polyurethane foam according to the present invention can be prepared by the foaming of a polyurethane raw material containing a polyol component, a polyisocyanate component, a catalyst, a blowing agent, and a foam stabilizer in the following amounts, followed by reticulation. However, a method for manufacturing the polyurethane foam is not limited to this.

[Composition of polyurethane raw material]

Polyol component: 100 parts by weight

Polyisocyanate component: 35 to 40 parts by weight

Blowing agent (water): 1 to 2 parts by weight

Amine catalyst (only as a foaming catalyst): 0.20 to 0.50 part by weight

Tin catalyst: 0.02 to 0.1 part by weight

Foam stabilizer: 0 to 0.1 part by weight

Polyols commonly used in the production of polyurethane foams can be used as the polyol component. Such a polyol is selected so that the resulting polyurethane foam can have a glass transition point near room temperature (0 to 60 degree C.).

Preferably, the polyol is at least one selected from the group consisting of polyoxyalkylene polyols, polyoxyalkylene polyols containing vinyl polymers, polyester polyols, and polyoxyalkylene polyester block copolymer polyols.

A polyoxyalkylene polyol may be an adduct of an initiator, such as water, an alcohol, an amine, or ammonia, with an alkylene oxide. Examples of an alcohol serving as an initiator include univalent or polyvalent alcohols, including univalent alcohols, such as methanol and ethanol, bivalent alcohols, such as ethylene glycol and propylene glycol, tervalent alcohols, such as glycerin and trimethylolpropane, quadrivalent alcohols, such as pentaerythritol, sexivalent alcohols, such as sorbitol, and octavalent alcohols, such as sucrose. Examples of an amine serving as an initiator include univalent or polyvalent amines, including univalent amines, such as dimethylamine and diethylamine, bivalent amines, such as, methylamine and ethylamine, tervalent amines, such as, monoethanolamine, diethanolamine, and triethanolamine, quadrivalent amines, such as ethylenediamine, and quinquevalent amines, such as diethylenetriamine. Preferably, the initiator is a univalent or sexivalent alcohol or a univalent or quinquevalent amine.

The alkylene oxide may be ethylene oxide, propylene oxide, 1,2-, 1,3-, 1,4-, or 2,3-butylene oxide or a combination thereof. Among these, the alkylene oxide is preferably propylene oxide and/or ethylene oxide. When propylene oxide and ethylene oxide are used in combination, the adduct may be a block adduct or a random adduct. A block adduct is preferred.

The polyoxyalkylene polyols containing vinyl polymers may be prepared by polymerizing a vinyl monomer, such as acrylonitrile or styrene, in a polyoxyalkylene polyol described above in the presence of a radical and stably dispersing the product. The amount of a vinyl polymer in the polyoxyalkylene polyol is typically 15 to 45% by weight.

The polyester polyols may be prepared by condensation polymerization of one or at least two compounds having at least two hydroxyl groups, such as, ethylene glycol, diethylene glycol, triethylene glycol, 1,2-propylene glycol, trimethylene glycol, 1,3 or 1,4-butyleneglycol, hexamethylene glycol, decamethylene glycol, glycerin, trimethylolpropane, pentaerythritol, and/or sorbitol, and one or at least two compounds having at least two carboxyl group, such as adipic acid, succinic acid, malonic acid, maleic acid, tartaric acid, pimelic acid, sebacic acid, phthalic acid, terephthalic acid, isophthalic acid, and/or trimellitic acid. The polyester polyols may be prepared by ring-opening polymerization of ε-caprolactone or the like.

Examples of polyoxyalkylene polyester block copolymer polyols include, as described in Japanese Examined Patent Application Publication No. 48-10078, one containing polyester chain blocks in a polyoxyalkylene polyol, that is, a polyoxyalkylene polyol or its derivative having hydroxyl groups in which a portion replacing a hydrogen atom of each hydroxyl group is expressed by a general formula (1):

[Formula 1]
—(CO—R₁—COO—R₂—O)ₙ—H (1)
(wherein, R₁ and R₂ are bivalent hydrocarbon groups, and n is a number greater than 1 on average).

In the general formula (1), the bivalent hydrocarbon residue denoted by R₁ may be a saturated aliphatic or aromatic polycarboxylic acid residue. The bivalent hydrocarbon residue denoted by R₂ may be a residue resulting from the cleavage of a compound having a cyclic ether group. Preferably, n is a number of 1 to 20. These polyoxyalkylene polyester block copolymer polyols can be prepared by allowing a polyoxyalkylene polyol to react with a polycarboxylic acid anhydride and an alkylene oxide.

Preferably, the polyol contains a polyol (a-1) having an average number of functional groups of 1.5 to 4.5 and a hydroxyl value of 20 to 70 mg-KOH/g, preferably 30 to 60 mg-KOH/g and a polyol (a-2) having an average number of functional groups of 1.5 to 4.5 and a hydroxyl value of 140 to 300 mg-KOH/g, preferably 200 to 270 mg-KOH/g. The average number of functional groups less than 1.5 may result in remarkable degradation in physical properties of the resulting polyurethane foam, such as the permanent strain after dry heat. The average number of functional groups more than 4.5 may result in reduced elongation and higher hardness, leading to degradation in physical properties of the resulting polyurethane foam, such as tensile strength. The polyurethane foam formed of the polyol (a-1) and the polyol (a-2) having different hydroxyl values of 20 to 70 mg-KOH/g and 140 to 300 mg-KOH/g, respectively, may have glass transition points in temperature ranges not only of 0 to 60 degree C. but also of −70 to −20 degree C. The polyurethane foam has an excellent low-resilience characteristic at room temperature and exhibits a small increase in hardness even at a low temperature.

Preferably, the polyol component contains 32 to 80% by weight of polyol (a-1) and 20 to 68% by weight of polyol (a-2). The polyol (a-1) less than 32% by weight and the polyol (a-2) more than 68% by weight may result in an increase of rigidity in the resulting polyurethane foam. The polyol (a-1) more than 80% by weight and the polyol (a-2) less than 20% by weight may result in high rebound resilience at room temperature. In particular, the polyol component preferably contains 34 to 75% by weight of polyol (a-1) and 25 to 66% by weight of polyol (a-2).

Preferably, the polyol (a-1) contains a polyoxyalkylene polyol and a polyoxyalkylene polyester block copolymer polyol. The inclusion of the polyoxyalkylene polyol and the polyoxyalkylene polyester block copolymer polyol can lower the rebound resilience of the resulting polyurethane foam. In this case, the polyol (a-1) preferably contains 30 to 70% by weight of the polyoxyalkylene polyol and 30 to 70% by weight of the polyoxyalkylene polyester block copolymer polyol. In these ranges, the largest effect of lowering the rebound resilience is achieved.

Preferably, the polyol (a-2) is an polyoxyalkylene polyol containing oxyethylene units in oxyalkylene units. When the polyol (a-2) is a polyoxyalkylene polyol and contains oxyethylene units in oxyalkylene units, the resulting polyurethane foam can easily have glass transition points in temperature ranges of −70 to −20 degree C. and 0 to 60 degree C. In this case, the oxyethylene units are preferable at least 20% by weight and more preferably at least 60% by weight of the oxyalkylene units. Increase of the oxyethylene units in the oxyalkylene units can reduce the rebound resilience.

The polyisocyanate component may be a known polyisocyanate commonly used in the production of polyurethane foams. Examples of polyisocyanate include aromatic polyisocyanates, such as 2,4- or 2,6-tolylene diisocyanate (TDI), diphenylmethane diisocyanate (MDI), phenylene diisocyanate (PDI), and naphthalene diisocyanate (NDI), aromatic aliphatic polyisocyanates, such as 1,3- or 1,4-xylylene diisocyanate (XDI), aliphatic polyisocyanates, such as hexamethylene diisocyanate (HDI), alicyclic polyisocyanates, such as 3-isocyanatemethyl-3,5,5-trimethylcyclohexyl isocyanate (IPDI), 4,4′-methylene bis(cyclohexyl isocyanate) (H₁₂MDI), and 1,3- or 1,4-bis (isocyanatemethyl) cyclohexane (H₆XDI), and carbodiimide derivatives, biuret derivatives, allophanate derivatives, dimers, and trimers of these polyisocyanates, and polymethylene polyphenyl polyisocyanates (crude MDI, polymeric MDI). These polyisocyanates are used alone or in combination. Among these, aromatic polyisocyanates may be preferred, and TDI may be more preferred.

The polyisocyanate component is preferably added in an amount of 35 to 40 parts by weight per 100 parts by weight of the polyol component.

The catalyst may be a known catalyst commonly used in the production of polyurethane foams. The catalyst may be amine catalysts, including tertiary amines, such as triethylamine, triethylenediamine, and N-methylmorpholine, quaternary ammonium salts, such as tetraethyl hydroxyl ammonium, and imidazoles, such as imidazoles and 2-ethyl-4-methylimidazole, organometal catalysts, including organotin compounds, such as tin acetate, tin octanoate, dibutyltin dilaurate, and dibutyltin chloride, organolead compounds, such as lead octanoate and lead naphthenate, and organonickel compounds, such as nickel naphthenate. Among these catalysts, a combined use of an amine catalyst and an organometal catalyst is preferred. In particular, a combined use of a tertiary amine and an organotin compound is preferred.

In the production of low-resilience polyurethane foams, as an amine catalyst, triethylenediamine, which acts as a resinification catalyst, and bis(2-dimethylaminoethyl)ether, which acts as a foaming catalyst, are hitherto used in combination. However, such a combined use of two amine catalysts does not produce satisfactory open cells. The resulting polyurethane foam contracts easily after foaming and cannot have a large air bubble size. Thus, only a foaming catalyst is used in the present invention. Preferably, bis(2-dimethylaminoethyl)ether serving as a foaming catalyst in an amount of 0.20 to 0.50 part by weight per 100 parts by weight of the polyol component and a tin catalyst in an amount of 0.02 to 0.1 part by weight per 100 parts by weight of the polyol component are used.

The blowing agent may be a known blowing agent commonly used in the production of polyurethane foams. The blowing agent may be, for example, water and/or a halogen-substituted aliphatic hydrocarbon blowing agent, for example, trichlorofluoromethane, dichlorodifluoromethane, trichloroethane, trichloroethylene, tetrachloroethylene, methylene chloride, trichlorotrifluoroethane, dibromotetrafluoroethane, or carbon tetrachloride. These blowing agents may be used in combination. Preferably, water is used alone in the present invention. Preferably, the blowing agent is used in an amount of 1 to 2 parts by weight per 100 parts by weight of the polyol component.

The foam stabilizer may be a known foam stabilizer commonly used in the production of polyurethane foams, such as a siloxane-oxyalkylene block copolymer. Specifically, the foam stabilizer may be F-242T from Shin-Etsu Chemical Co., Ltd.

In the production of low-resilience polyurethane foams, a foam stabilizer is hitherto used in an amount of about 1 to 2 parts by weight per 100 parts by weight of a polyol component. However, a polyurethane foam having a large air bubble size cannot be produced with such an amount of foam stabilizer. Thus, preferably, in the present invention, a foam stabilizer is not used or is used in an amount of 0.1 part by weight or less, preferably 0.03 to 0.1 part by weight per 100 parts by weight of the polyol component.

In addition to the components described above, a raw material for a low-resilience highly air-permeable polyurethane foam according to the present invention may contain a flame retardant and other auxiliaries if necessary. The flame retardant may be a known flame retardant, such as tris(2-chloroethyl)phosphate or tris(2,3-dibromopropyl)phosphate, an organic powder, such as urea or thiourea, or an inorganic powder, such as a metal hydroxide or antimony trioxide. Other auxiliaries may be a coloring powder, such as pigment or dye, a powder, such as talc or graphite, a short glass fiber, or other inorganic extenders or organic solvents.

Foam molding of the polyurethane raw material produces a foam having a large air bubble size, that is, a cell count of 25 PPI or less, preferably 20 PPI or less, more preferably about 9 to 20 PPI. Removal of a skin of this foam produces a polyurethane foam having high air permeability.

A low-resilience highly air-permeable polyurethane foam according to the present invention has an air permeability of at least 200 cc/cm²/s as determined by JIS L 1096. In particular, a polyurethane foam having a cell count of 20 or less has a high air permeability of at least 250 cc/cm²/s.

A low-resilience highly air-permeable polyurethane foam according to the present invention preferably has a density of about 45 to 60 kg/m³.

A bed item according to the present invention includes a low-resilience highly air-permeable polyurethane foam according to the present invention. The bed item may be formed only of a low-resilience highly air-permeable polyurethane foam according to the present invention. The bed item may have a multilayered structure composed of a low-resilience highly air-permeable polyurethane foam according to the present invention and another material, wherein the low-resilience highly air-permeable polyurethane foam is provided as a surface layer. The other material may be at least one selected from the group consisting of

i) a polyurethane foam in which a polyether polyol and a polyester polyol are main raw materials,

ii) a nonwoven fabric,

iii) a woven fabric,

iv) a structure in which liquid, such as water, is enclosed, and

v) a polyolefin foam in which polyethylene, polypropylene, or ethylene-vinyl acetate (EVA) copolymer is a main raw material.

The bed item may be a pillow or a mattress.

A vehicle seat pad according to the present invention includes a main body of a seat pad and a skin material covering the main body of a seat pad, wherein the skin material is lined with a low-resilience highly air-permeable polyurethane foam according to the present invention. The skin material may be leather, cloth, or synthetic leather. The skin material may be bonded to a sheet material formed of a low-resilience highly air-permeable polyurethane foam according to the present invention having a thickness of about 2 to 50 mm with a urethane adhesive or the like.

In the pillow, the mattress, and the vehicle seat, the low-resilience highly air-permeable polyurethane foam disposed at least at their surface layers prevents “stuffy” feeling and gives comfortable feeling.

### EXAMPLES

The present invention will specifically be described with reference to the following examples and comparative examples.

The following raw materials were used in the following examples and comparative examples.

Polyol 1: “G250” from Mitsui Takeda Chemicals, Inc.
Polyether polyol
Average number of functional groups: 3
Hydroxyl value: 250 mg-KOH/g

Polyol 2: “3P56B” from Mitsui Takeda Chemicals, Inc.
Polyether polyol
Average number of functional groups: 3
Hydroxyl value: 56 mg-KOH/g

Polyol 3: “GP-3000” from Sanyo Chemical Industries, Ltd.
Polyether polyol
Average number of functional groups: 3
Hydroxyl value: 56 mg-KOH/g

Polyisocyanate: “TDI” from Mitsui Takeda Chemicals, Inc.

Blowing agent: water

Amine catalyst 1: “TEDAL-33” from Tosoh Corporation
Triethylenediamine in DPG
(Table illustrates the amount of triethylenediamine alone.)

Amine catalyst 2: “TOYOCAT-ET33B” from Tosoh Corporation
Bis(2-dimethylaminoethyl)ether in DPG
(Table illustrates the amount of bis(2-dimethylaminoethyl)ether alone.)

Tin catalyst: “KOSMOS29” from Goldschmidt GmbH
Tin ethylhexanoate

Foam stabilizer: “silicone foam stabilizer” from Shin-Etsu Chemical Co., Ltd.
F242T silicone

The resulting polyurethane foams were evaluated by the following methods.

[Foaming characteristics]

“Excellent” means a foam prepared by foam molding had open cells. “Poor” means a foam prepared by foam molding had closed cells.

[Number of cells]

A photograph of a horizontal cross section was taken and the number of air bubbles aligned on one inch in length was counted.

[Density]

Determined by JIS K 6400.

[Air permeability]

Determined by JIS L 1096.

[Resilience]

Determined by JIS K 6400.

### Examples 1 to 4

Polyurethane foams were prepared by ordinary foam molding of compounds listed in Table 1, and were evaluated for foaming characteristics and the cell count. Subsequently, a foam skin was removed. The resulting skinless foams were evaluated for the density, air permeability, and resilience. Table 1 illustrates the results.

### Comparative Examples 1 to 8

Polyurethane foams were prepared by ordinary foam molding of compounds listed in Table 1. Without the reticulation, the polyurethane foams were evaluated for foaming characteristics, the cell count, the density, air permeability, and resilience. Table 1 illustrates the results.

TABLE 1
(recalculated on the basis of pure amine content)

| | | Example | | | | Comparative Example | | | | | | | |
|---|---|---|---|---|---|---|---|---|---|---|---|---|---|
| | | 1 | 2 | 3 | 4 | 1 | 2 | 3 | 4 | 5 | 6 | 7 | 8 |
| Poly- | Polyol 1 | 30 | 30 | 30 | 30 | 0 | 0 | 0 | 30 | 30 | 30 | 30 | 30 |
| urethane | Polyol 2 | 70 | 70 | 70 | 70 | 0 | 35 | 60 | 70 | 70 | 70 | 70 | 70 |
| raw | Polyol 3 | 0 | 0 | 0 | 0 | 100 | 65 | 40 | 0 | 0 | 0 | 0 | 0 |
| materials | Polyiso- | 36 | 36 | 36 | 36 | 24 | 36 | 41 | 36 | 36 | 36 | 36 | 36 |
| (parts | cyanate | | | | | | | | | | | | |
| by | Water | 1.5 | 1.5 | 1.5 | 1.5 | 1.4 | 1.5 | 2.3 | 1.5 | 1.5 | 1.5 | 1.5 | 1.5 |
| weight) | Amine | 0.10 | 0 | 0 | 0 | 0.13 | 0.10 | 0.10 | 0.10 | 0.10 | 0.10 | 0.10 | 0 |
| | catalyst 1 | | | | | | | | | | | | |
| | Amine | 0.09 | 0.35 | 0.35 | 0.35 | 0.07 | 0.18 | 0.02 | 0.09 | 0.09 | 0.09 | 0.09 | 0.35 |
| | catalyst 2 | | | | | | | | | | | | |
| | Tin | 0.015 | 0.06 | 0.06 | 0.06 | 0.28 | 0.09 | 0.15 | 0.05 | 0.05 | 0.05 | 0.015 | 0.06 |
| | catalyst | | | | | | | | | | | | |
| | Foam | 0.20 | 0.05 | 0.05 | 0.08 | 0.6 | 0.80 | 2.00 | 1.50 | 0.50 | 0.50 | 0.20 | 0.05 |
| | stabilizer | | | | | | | | | | | | |

| | | | | | | | | | | | | |
|---|---|---|---|---|---|---|---|---|---|---|---|---|
| Foaming | Excel- | Excel- | Excel- | Excel- | Excel- | Excel- | Excel- | Excel- | Excel- | Poor | Excel- | Excel- |
| characteristics | lent | lent | lent | lent | lent | lent | lent | lent | lent | | lent | lent |
| Reticulation | Yes | Yes | Yes | Yes | No | No | No | No | No | No | No | No |
| Number of cells | 25 | 18 | 16 | 18 | 54 | 58 * | 56 * | 42 | 30 | 27 | 21 | 18 |
| (PPI) | | | | | | | | | | | | |
| Density (kg/m³) | 53.0 | 51.6 | 52.8 | 50.9 | 59.5 | 58.0 | 40.2 | 53.5 | 54.6 | N/A | 52.7 | 51.8 |
| Air permeability | 237.0 | 296.0 | 343.0 | 306.0 | 54.0 | 8.7 | 81.2 | 1.9 | 0.4 | N/A | 10.0 | 3.0 |
| (cc/cm²/sec) | | | | | | | | | | | | |
| Rebound | 3 | 3 | 3 | 3 | 38 | 16 | 9 | 2 | 3 | N/A | 3 | 3 |
| resilience (%) | | | | | | | | | | | | |

* A mixture of fine cells and coarse cells. The cell number varied widely.

Table 1 shows that the present invention provides a low-resilience polyurethane foam having high air permeability.

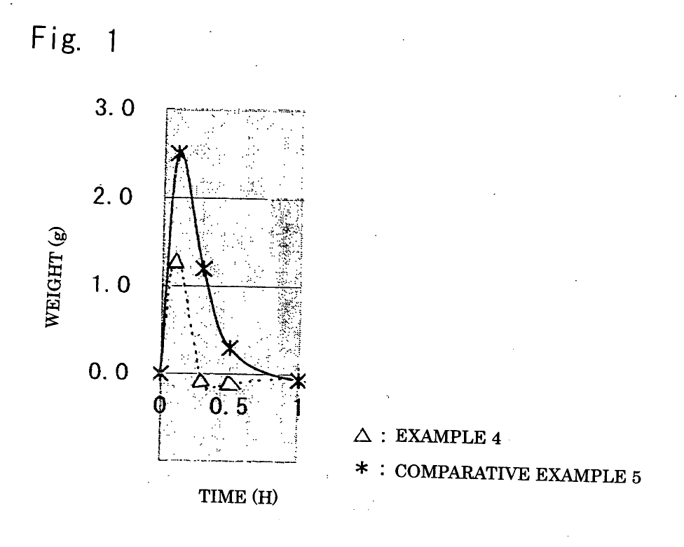

Furthermore, polyurethane foams of Example 4 and Comparative Example 5 were examined for change in weight when they were dried in an oven at 80 degree C. after washing in water. FIG. 1 shows that the polyurethane foam according to the present invention dried in a shorter time.

### INDUSTRIAL APPLICABILITY

A low-resilience highly air-permeable polyurethane foam according to the present invention is useful for the applications including a bed item, such as a pillow and a mattress, and a vehicle seat pad.

1. A low-resilience highly air-permeable polyurethane foam prepared by the foaming of a polyurethane raw material containing a polyol component, a polyisocyanate component, a catalyst, and a blowing agent, followed by reticulation, the low-resilience highly air-permeable polyurethane foam having a glass transition point near room temperature and a cell count of 25 PPI or less.

2. The low-resilience highly air-permeable polyurethane foam according to claim 1, wherein the cell count is 20 PPI or less.

3. The low-resilience highly air-permeable polyurethane foam according to claim 1, wherein the cell count is 9 to 20 PPI.

4. The low-resilience highly air-permeable polyurethane foam according to claim 1, wherein the air permeability of the polyurethane foam determined according to JIS L 1096 (air permeability of a nonwoven fabric) is at least 200 cc/cm²/s.

5. The low-resilience highly air-permeable polyurethane foam according to claim 1, wherein the density of the polyurethane foam is 45 to 60 kg/m³.

6. The low-resilience highly air-permeable polyurethane foam according to claim 1, wherein a foam stabilizer is contained in the polyurethane raw material in an amount of 0 to 0.1 part by weight per 100 parts by weight of the polyol component.

7. The low-resilience highly air-permeable polyurethane foam according to claim 1, wherein the polyurethane raw material contains a foaming catalyst as an amine catalyst and is free from an amine resinification catalyst.

8. The low-resilience highly air-permeable polyurethane foam according to claim 7, wherein the foaming catalyst is bis(2-dimethylaminoethyl)ether.

9. A bed item comprising the low-resilience highly air-permeable polyurethane foam according to claim 1.

10. A bed item having a multilayered structure composed of the low-resilience highly air-permeable polyurethane foam according to claim 1 and another material, wherein the low-resilience highly air-permeable polyurethane foam is provided as a surface layer.

11. The bed item according to claim 10, wherein the other material is at least one selected from the group consisting of
i) a polyurethane foam in which a polyether polyol and a polyester polyol are main raw materials,
ii) a nonwoven fabric,
iii) a woven fabric,
iv) a structure in which liquid, such as water, is enclosed, and
v) a polyolefin foam in which polyethylene, polypropylene, or an ethylene-vinyl acetate (EVA) copolymer is a main raw material.

12. The bed item according to claim 9, wherein the bed item is a pillow or a mattress.

13. The bed item according to claim 10, wherein the bed item is a pillow or a mattress.

14. A vehicle seat pad comprising a main body of a seat pad and a skin material covering the main body of a seat pad, wherein the skin material is lined with the low-resilience highly air-permeable polyurethane foam according to claim 1.
